(19) United States
(12) Patent Application Publication
(10) Pub. No.: US 2025/0303549 A1
(43) Pub. Date: Oct. 2, 2025

(54) ROBOT AND ROBOT SYSTEM

(71) Applicant: SEIKO EPSON CORPORATION, Tokyo (JP)

(72) Inventor: Yosaku TAMURA, AZUMINO-SHI (JP)

(21) Appl. No.: 19/092,986

(22) Filed: Mar. 27, 2025

(30) Foreign Application Priority Data
Mar. 28, 2024 (JP) 2024-055115

(51) Int. Cl. B25J 9/00; B25J 9/16; B25J 13/08

(52) U.S. Cl. CPC B25J 9/0009; B25J 9/0087; B25J 9/1615; B25J 13/087

(57) ABSTRACT

A robot includes a base, a first arm that is joined to the base and that rotates around a first rotation axis with respect to the base, a second arm that is joined to the first arm and that rotates around a second rotation axis, which is parallel to the first rotation axis, with respect to the first arm, and an inertia sensor module that is disposed at the second arm, in which the second arm has an arm base that is joined to the first arm, a plurality of pillars that are erected from the arm base toward one side in a direction along the second rotation axis, and a mounting member that is fixed to the plurality of pillars, and the inertia sensor module is fixed to the mounting member.

### CROSS-REFERENCE TO RELATED APPLICATIONS

The present application is based on, and claims priority from JP Application Serial Number 2024-055115, filed Mar. 28, 2024, the disclosure of which is hereby incorporated by reference herein in its entirety.

### BACKGROUND OF THE INVENTION

### 1. Technical Field

The present disclosure relates to a robot and a robot system.

### 2. Related Art

A SCARA robot (horizontal articulated robot) described in JP-A-2013-111665 has a base, a first arm that is rotatably joined around a first rotation axis along a vertical direction with respect to the base and a second arm that is rotatably joined around a second rotation axis along the vertical direction with respect to the first arm. In addition, in the second arm, a gyro sensor module fixed to a bottom base of the second arm is disposed via a spacer.

However, in a configuration where the bottom base of the second arm supports the gyro sensor module via the spacer as described above, oscillation of the second arm is easily transmitted to the gyro sensor module. For this reason, there is a concern in which detection accuracy of the gyro sensor module is decreased due to the oscillation of the second arm.

### SUMMARY OF THE INVENTION

According to an aspect of the present disclosure, there is provided a robot including:
a base;
a first arm that is joined to the base and that rotates around a first rotation axis with respect to the base;
a second arm that is joined to the first arm and that rotates around a second rotation axis, which is parallel to the first rotation axis, with respect to the first arm; and
an inertia sensor module that is disposed at the second arm, in which
the second arm has an arm base that is joined to the first arm, a plurality of pillars that are erected from the arm base toward one side in a direction along the second rotation axis, and a mounting member that is fixed to the plurality of pillars, and
the inertia sensor module is fixed to the mounting member.

According to another aspect of the present disclosure, there is provided a robot system including:
a robot; and
a control device that controls driving of the robot, in which
the robot includes
   a base,
   a first arm that is joined to the base and that rotates around a first rotation axis with respect to the base,
   a second arm that is joined to the first arm and that rotates around a second rotation axis, which is parallel to the first rotation axis, with respect to the first arm, and an inertia sensor module that is disposed at the second arm,
the second arm has an arm base that is joined to the first arm, a plurality of pillars that are erected from the arm base toward one side in a direction along the second rotation axis, and a mounting member that is fixed to the plurality of pillars, and
the inertia sensor module is fixed to the mounting member.

### BRIEF DESCRIPTION OF DRAWINGS

FIG. 1 is a side view illustrating a robot according to a first embodiment.

FIG. 2 is a cross-sectional view illustrating a joined portion between a base and a first arm.

FIG. 3 is a cross-sectional view of a second arm viewed from one side in a horizontal direction.

FIG. 4 is a cross-sectional view of the second arm viewed from the other side in the horizontal direction.

FIG. 5 is a top view illustrating an inside of the second arm.

FIG. 6 is a perspective view illustrating a distal end portion of a frame.

FIG. 7 is a cross-sectional view illustrating the enlarged distal end portion of the frame.

FIG. 8 is a top view illustrating the inside of the second arm.

FIG. 9 is a perspective view illustrating a vicinity of a mounting member.

FIG. 10 is an exploded perspective view illustrating the vicinity of the mounting member.

FIG. 11 is a top view illustrating an inside of a second arm of a robot according to a second embodiment.

FIG. 12 is an exploded perspective view illustrating a vicinity of a mounting member.

### DETAILED DESCRIPTION OF THE INVENTION

Hereinafter, a robot and a robot system of the present disclosure will be described in detail based on an embodiment illustrated in the accompanying drawings.

### First Embodiment

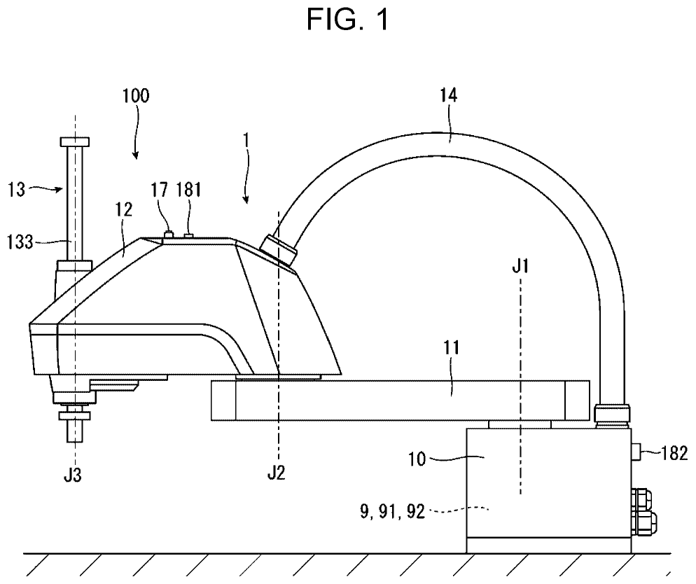

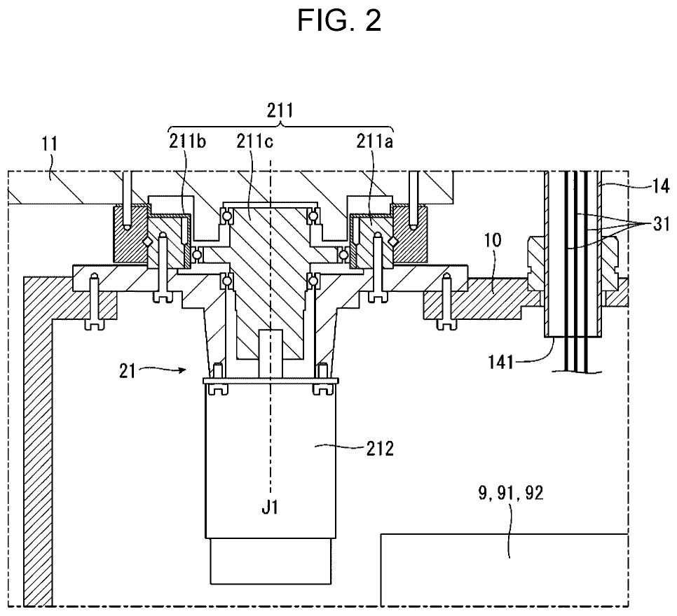

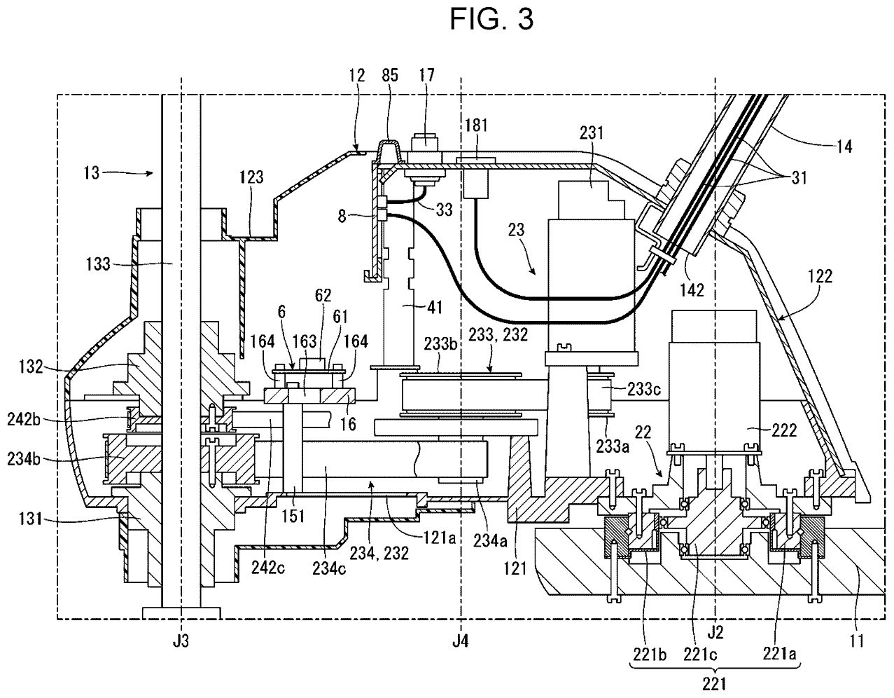

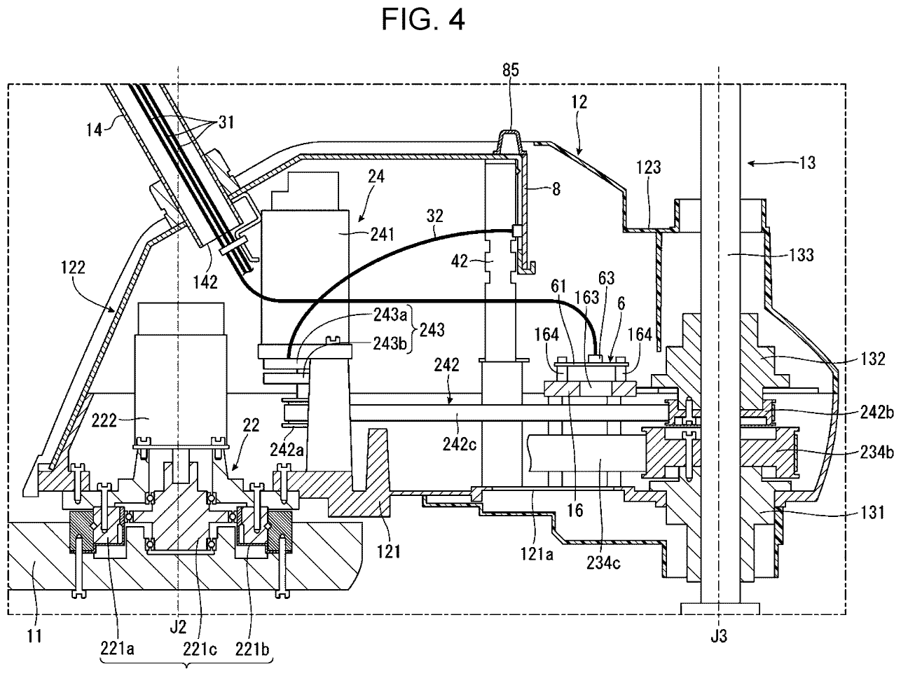

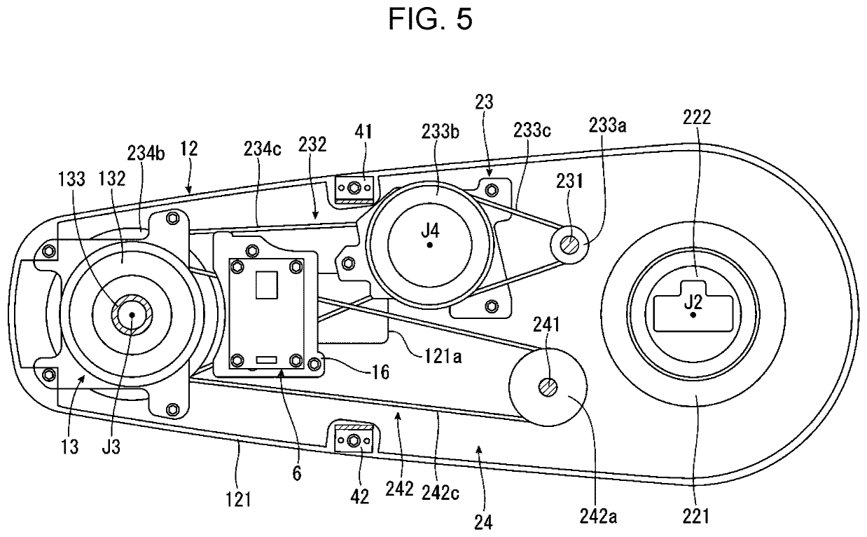

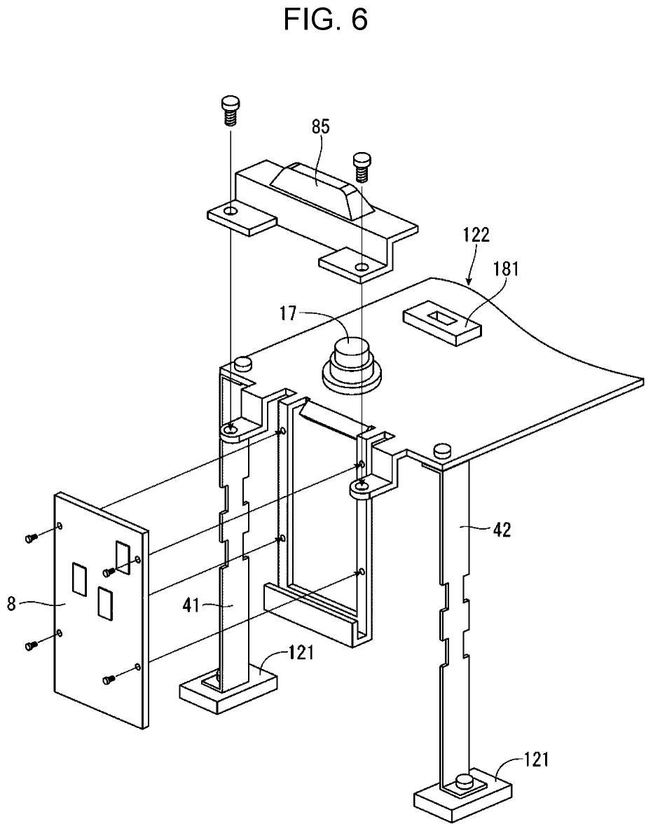

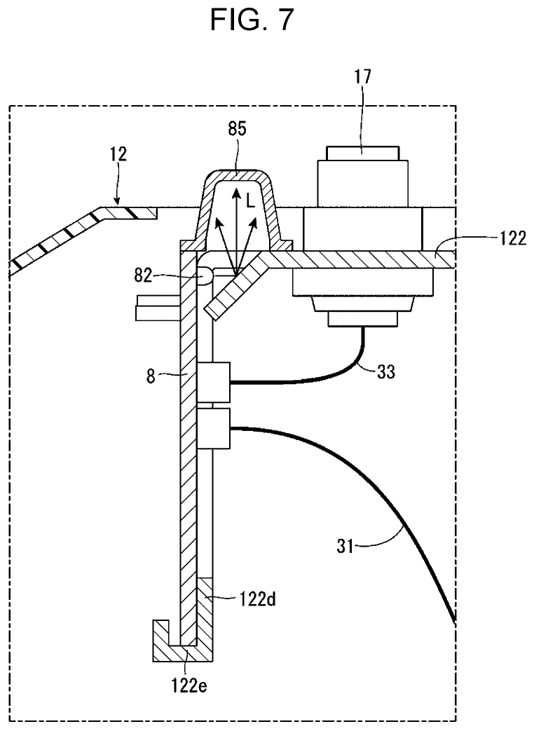

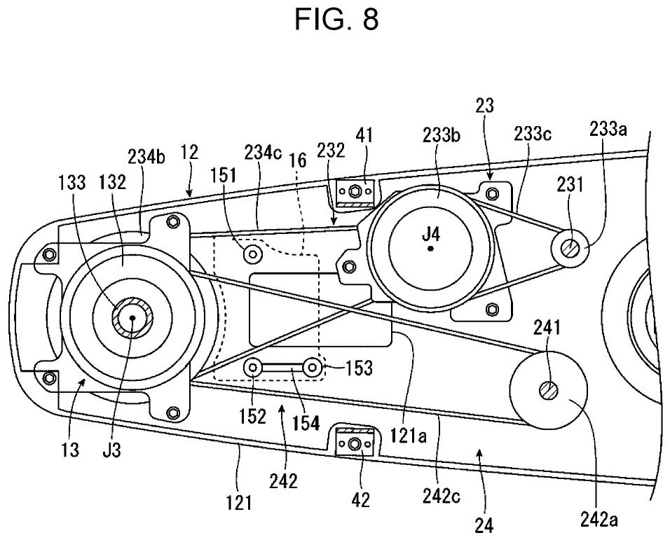

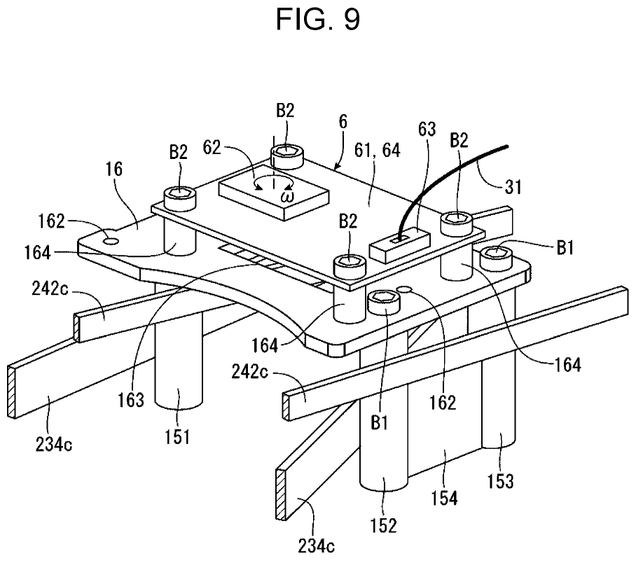

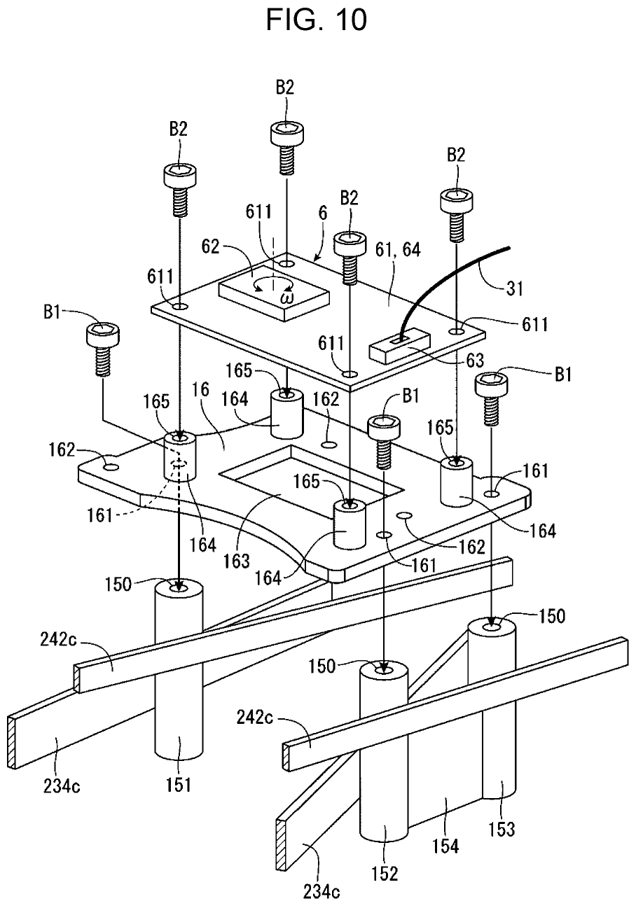

FIG. 1 is a side view illustrating a robot according to a first embodiment. FIG. 2 is a cross-sectional view illustrating a joined portion between a base and a first arm. FIG. 3 is a cross-sectional view of a second arm viewed from one side in a horizontal direction. FIG. 4 is a cross-sectional view of the second arm viewed from the other side in the horizontal direction. FIG. 5 is a top view illustrating an inside of the second arm. FIG. 6 is a perspective view illustrating an enlarged distal end portion of a frame. FIG. 7 is a cross-sectional view illustrating the enlarged distal end portion of the frame. FIG. 8 is a top view illustrating the inside of the second arm. FIG. 9 is a perspective view illustrating a vicinity of a mounting member. FIG. 10 is an exploded perspective view illustrating the vicinity of the mounting member.

An up/down direction in FIG. 1 matches a vertical direction. For this reason, hereinafter, an upper side in FIG. 1 will also be referred to as “up”, and a lower side will also be referred to as “down”. In addition, in the present specification, the term “vertical” means not only including a case of matching the vertical, but also including a case of being inclined with respect to the vertical within a range in which an effect of the present disclosure can be exhibited, for example, a case of being inclined within +5° with respect to the vertical. Similarly, in the present specification, the term “parallel” means not only including a case where two objects are parallel to each other, but also a case where the two objects are inclined from the parallel within a range in which the effect of the present disclosure can be exhibited, for example, a case where the two objects are inclined within +5° with respect to the parallel.

A robot system 100 illustrated in FIG. 1 has a robot 1 and a control device 9 that controls driving of the robot 1.

### Control Device 9

As illustrated in FIG. 1, the control device 9 has, for example, a control substrate 91 and a power supply substrate 92. However, without being limited thereto, the control substrate 91 and the power supply substrate 92 may be one substrate.

The control substrate 91 collectively controls the driving of each portion of the robot 1. The control substrate 91 includes a central processing unit (CPU), a random access memory (RAM), and a read only memory (ROM). The functions described above are achieved as the CPU reads and executes a program and data stored in the ROM. In addition, the control substrate 91 is electrically coupled to a host computer (not illustrated) and controls driving of each portion of the robot 1 based on a command from the host computer. However, without being limited thereto, a circuit and the like of the control substrate 91 may be divided into a plurality of substrates.

The power supply substrate 92 supplies power to the control substrate 91. The power supply substrate 92 includes a conversion circuit that converts power supplied from the outside into a predetermined value to supply the power to the control substrate 91. The conversion circuit varies depending on the configuration of the robot 1, but examples thereof include an AC/DC conversion circuit that converts an alternating current (AC) to a direct current (DC) and a booster circuit or a step-down circuit that converts a voltage level of a signal. However, without being limited thereto, a circuit and the like of the power supply substrate 92 may be divided into a plurality of substrates.

However, the configuration of the control device 9 is not particularly limited insofar as the driving of the robot 1 can be controlled. In addition, the control device 9 is disposed in a base 10 of the robot 1 in the present embodiment, but the disposition of the control device 9 is not particularly limited. For example, the control device 9 may be installed outside the base 10. In this case, the robot 1 and the control device 9 may be coupled by a cable or may be wirelessly coupled.

### Robot 1

The robot 1 is a horizontal articulated robot (SCARA robot). As illustrated in FIG. 1, the robot 1 has the base 10 fixed to a floor or the like, a first arm 11 rotatably joined to the base 10, a second arm 12 rotatably joined to the first arm 11, a work head 13 disposed at the second arm 12, and a duct 14 that couples the base 10 and the second arm 12.

As illustrated in FIG. 2, the first arm 11 is joined to the base 10 at a proximal end portion thereof and rotates around a first rotation axis J1 along the vertical direction with respect to the base 10.

As illustrated in FIGS. 3 and 4, the second arm 12 is joined to the first arm 11 at a proximal end thereof and rotates around a second rotation axis J2, which is parallel to the first rotation axis J1, with respect to the first arm 11. In addition, the second arm 12 includes a hard arm base 121 joined to the first arm 11, a frame 122 fixed to the arm base 121, and a cover 123 covering the arm base 121 from above the frame 122. For example, the arm base 121 and the frame 122 are made of a lightweight and hard metal material such as aluminum, and the cover 123 is made of a lightweight resin material.

As illustrated in FIG. 1, the duct 14 is a tubular member disposed outside the first arm 11 and directly couples the base 10 and the second arm 12 without passing through the first arm 11. In addition, as illustrated in FIGS. 2 to 4, the duct 14 has a proximal end portion coupled to the base 10, has a distal end portion coupled to the second arm 12, and has a proximal end opening 141 that faces the inside of the base 10 and a distal end opening 142 that faces the inside of the second arm 12. Accordingly, the base 10 and the second arm 12 communicate with each other via the duct 14. In addition, a plurality of pieces of wiring 31 are drawn between the base 10 and the second arm 12 via the duct 14, and electronic components disposed in the second arm 12 (for example, motors 222, 231, and 241, a brake control substrate 8, a connector 181, a brake release button 17, and the like to be described later) and electronic components disposed in the base 10 (for example, the control substrate 91, a connector 182 to be described later, and the like) are electrically coupled via the pieces of wiring 31. In addition, the wiring 31 is drawn to a distal end side of motors 231 and 241 through a gap between the motors 231 and 241, for example.

As illustrated in FIGS. 3 and 4, the work head 13 is disposed at a distal end portion of the second arm 12. In addition, the work head 13 has a spline nut 131 and a ball screw nut 132 that are coaxially disposed in the vertical direction and a spline shaft 133 that is inserted through the spline nut 131 and the ball screw nut 132. In such a work head 13, when the spline nut 131 is rotated, the spline shaft 133 rotates around a central axis thereof, which is the third rotation axis J3 parallel to the first rotation axis J1, and moves linearly (up and down) along the third rotation axis J3. When the ball screw nut 132 is rotated, the spline shaft 133 moves linearly along the third rotation axis J3. When both the spline nut 131 and the ball screw nut 132 are rotated, the spline shaft 133 rotates around the third rotation axis J3. Although not illustrated, an end effector according to work is mounted on a lower end portion of the spline shaft 133.

In addition, as illustrated in FIGS. 2 and 3, the robot 1 has a first arm drive mechanism 21 that rotates the first arm 11 around the first rotation axis J1 with respect to the base 10 and a second arm drive mechanism 22 that rotates the second arm 12 around the second rotation axis J2 with respect to the first arm 11.

As illustrated in FIG. 2, the first arm drive mechanism 21 has a decelerator 211 that rotatably joins the base 10 and the first arm 11 and an encoder built-in motor 212 disposed in the base 10. The motor 212 is a servo motor, particularly a three-phase motor driven by a three-phase alternating current, and is fixed to the base 10. The decelerator 211 is a wave gear device, a circular spline 211a is fixed to the base 10, and a flex spline 211b is fixed to the first arm 11. In addition, a rotation shaft of the motor 212 is fixed to a wave generator 211c. For this reason, the wave generator 211c rotates together with the rotation of the motor 212, and further, the flex spline 211b rotates with a predetermined deceleration ratio with respect to the rotation of the wave generator 211c. As a result, the first arm 11 rotates around the first rotation axis J1 with respect to the base 10. However, the configuration of the first arm drive mechanism 21 is not particularly limited.

The second arm drive mechanism 22 has the same configuration as that of the first arm drive mechanism 21. As illustrated in FIGS. 3 and 4, the second arm drive mechanism 22 has a decelerator 221 that rotatably joins the first arm 11 and the second arm 12 and an encoder built-in motor 222 disposed in the second arm 12. The motor 222 is a servo motor, particularly a three-phase motor driven by a three-phase alternating current, and is fixed to the arm base 121. The decelerator 221 is a wave gear device, a circular spline 221a is fixed to the arm base 121, and a flex spline 221b is fixed to the first arm 11. In addition, a rotation shaft of the motor 222 is fixed to a wave generator 221c. For this reason, the wave generator 221c rotates together with the rotation of the motor 222, and further, the flex spline 221b rotates with a predetermined deceleration ratio with respect to the rotation of the wave generator 221c. As a result, the second arm 12 rotates around the second rotation axis J2 with respect to the first arm 11. However, the configuration of the second arm drive mechanism 22 is not particularly limited.

In addition, as illustrated in FIGS. 3 to 5, the robot 1 has a spline shaft first drive mechanism 23 that rotates the spline nut 131 to rotate and linearly move the spline shaft 133 and a spline shaft second drive mechanism 24 that rotates the ball screw nut 132 to linearly move the spline shaft 133.

As illustrated in FIG. 3, the spline shaft first drive mechanism 23 has the encoder built-in motor 231 that is a first motor disposed in the second arm 12 and a deceleration mechanism 232 that is a first power transmission mechanism which transmits rotation of the motor 231 to the spline nut 131. The motor 231 is a servo motor, particularly a three-phase motor driven by a three-phase alternating current, and is fixed to the arm base 121.

The deceleration mechanism 232 has a first deceleration mechanism 233 and a second deceleration mechanism 234. The first deceleration mechanism 233 has a pulley 233a attached to a rotation shaft of the motor 231, a first intermediate pulley 233b rotatably supported around a fourth rotation axis J4, which is parallel to the second rotation axis J2, with respect to the arm base 121, and a belt 233c wound around the pulley 233a and the first intermediate pulley 233b. The first intermediate pulley 233b has a diameter larger than that of the pulley 233a. The second deceleration mechanism 234 has a second intermediate pulley 234a that is coaxially disposed with the first intermediate pulley 233b and that rotates around the fourth rotation axis J4 together with the first intermediate pulley 233b, a pulley 234b that is a first pulley fixed to the spline nut 131, and a belt 234c that is a first belt wound around the second intermediate pulley 234a and the pulley 234b. The second intermediate pulley 234a has a diameter smaller than that of the first intermediate pulley 233b, and the pulley 234b has a diameter larger than that of the second intermediate pulley 234a.

In such a configuration, rotation of the motor 231 is transmitted to the first intermediate pulley 233b via the pulley 233a and the belt 233c, and the first intermediate pulley 233b and the second intermediate pulley 234a rotate integrally around the fourth rotation axis J4. In addition, rotation of the second intermediate pulley 234a is transmitted to the pulley 234b via the belt 234c, and the pulley 234b and the spline nut 131 integrally rotate around the third rotation axis J3. Accordingly, the spline shaft 133 rotates and moves linearly. As described above, by using the deceleration mechanism 232 that includes the first deceleration mechanism 233 and the second deceleration mechanism 234, the rotation of the motor 231 can be decelerated in two stages, and the spline nut 131 can be rotated with larger torque.

However, the configuration of the spline shaft first drive mechanism 23 is not particularly limited. For example, the first power transmission mechanism is not limited to the deceleration mechanism 232 insofar as rotation of the motor 231 can be transmitted to the spline nut 131. A configuration where the belt 233c and the first and second intermediate pulleys 233b and 234a are omitted, and the belt 234c is wound around the pulleys 233a and 234b may be adopted. In addition, the first power transmission mechanism may be a mechanism that transmits the rotation of the motor 231 to the spline nut 131 at a constant speed or may be a mechanism that accelerates the rotation of the motor 231 to transmit the rotation to the spline nut 131.

As illustrated in FIG. 4, the spline shaft second drive mechanism 24 has the encoder built-in motor 241 which is a second motor disposed in the second arm 12, a deceleration mechanism 242 that is a second power transmission mechanism which transmits rotation of the motor 241 to the ball screw nut 132, and a brake 243 for the motor 241. The motor 241 is a servo motor, particularly a three-phase motor driven by a three-phase alternating current and is fixed to the arm base 121.

The deceleration mechanism 242 has a pulley 242a attached to a rotation shaft of the motor 241, a pulley 242b that is a second pulley attached to the ball screw nut 132, and a belt 242c that is a second belt wound around the pulleys 242a and 242b. In such a configuration, rotation of the motor 241 is transmitted to the pulley 242b via the pulley 242a and the belt 242c, and the pulley 242b and the ball screw nut 132 integrally rotate around the third rotation axis J3. Accordingly, the spline shaft 133 linearly moves. As described above, the rotation of the motor 241 can be decelerated by using the deceleration mechanism 242, and the ball screw nut 132 can be rotated with sufficiently large torque.

However, the configuration of the spline shaft second drive mechanism 24 is not particularly limited. For example, the second power transmission mechanism is not limited to the deceleration mechanism 242 insofar as rotation of the motor 241 can be transmitted to the ball screw nut 132. A configuration of having a two-stage deceleration mechanism such as the spline shaft first drive mechanism 23 described above may be adopted. In addition, the second power transmission mechanism may be a mechanism that transmits the rotation of the motor 241 to the ball screw nut 132 at a constant speed or may be a mechanism that accelerates the rotation of the motor 241 to transmit the rotation to the ball screw nut 132.

The brake 243 is an electromagnetic brake attached to the motor 241 and has a pair of plates 243a and 243b disposed to face each other. In addition, one plate 243a is fixed to the motor 241, and the other plate 243b is fixed to the rotation shaft of the motor 241 and rotates together with the rotation shaft. Then, through ON/OFF control of power supply, a brake state where the plates 243a and 243b are brought into contact with each other to restrict the rotation of the rotation shaft and a brake release state where the plates 243a and 243b are separated from each other to allow the rotation of the rotation shaft are switched. In particular, the brake 243 of the present embodiment is an unexcited operation type electromagnetic brake, is in the brake release state when power is supplied (ON), and is in the brake state when power is cut off (OFF). However, the configuration of the brake 243 is not particularly limited.

Main portions of the robot 1 are briefly described hereinbefore. Next, the second arm 12 will be described in more detail.

As described above, the second arm 12 has the hard arm base 121 joined to the first arm 11, the frame 122 fixed to the arm base 121, and the cover 123 covering the arm base 121 from above the frame 122.

As illustrated in FIGS. 3 and 4, the duct 14 is coupled to the frame 122. In addition, the connector 181 and the brake release button 17 for releasing the brake 243 are disposed at the frame 122. In addition, the connector 181 and the brake release button 17 are exposed to the outside of the second arm 12 without being covered with the cover 123. As illustrated in FIG. 1, the connector 182 that forms a pair with the connector 181 is disposed on a back surface of the base 10, and the connectors 181 and 182 are coupled to each other via the wiring 31.

In addition, a lens 85 that is illuminated by light L incident from a light emitting element 82 to be described later is disposed at the frame 122. In addition, the lens 85 is exposed to the outside of the second arm 12 without being covered with the cover 123.

In addition, as illustrated in FIG. 6, the distal end portion of the frame 122 is supported by the arm base 121 via a pair of support members 41 and 42. As described above, since the frame 122 is a cantilever beam, a distal end side is easily bent up and down. For this reason, for example, there is a concern in which the frame 122 is plastically deformed by stress applied when a user inserts a connector into the connector 181, when the brake release button 17 is pressed, or when wiring or a device coupled to the connector 181 is installed on the frame 122. Thus, by supporting the distal end portion of the frame 122 with the pair of support members 41 and 42, the deformation of the frame 122 can be effectively suppressed.

In addition, as illustrated in FIGS. 6 and 7, the brake control substrate 8 that controls the brake 243 is fixed to the frame 122. As illustrated in FIGS. 3 and 4, the brake control substrate 8 is electrically coupled to the control substrate 91 via the wiring 31. In addition, the brake control substrate 8 is electrically coupled to the brake 243 via wiring 32 and is electrically coupled to the brake release button 17 via wiring 33. Such a brake control substrate 8 controls driving of the brake 243 based on a command from the control substrate 91 and switches between the brake state/brake release state. In addition, the brake control substrate 8 controls the driving of the brake 243 based on the operation of the brake release button 17 and switches between the brake state/brake release state.

In addition, as illustrated in FIG. 7, the robot 1 has the light emitting element 82 mounted on the brake control substrate 8. The light emitting element 82 is, for example, a light emitting diode (LED). The light L emitted from the light emitting element 82 is diffusely reflected upward by the frame 122 and then is incident to the lens 85. Accordingly, the lens 85 is illuminated. For this reason, by controlling driving of the light emitting element 82 to switch the lighting/blinking/extinguishing of the lens 85 or to switch a light emission color of the lens 85, the user can be notified of various types of information via the lens 85.

The brake control substrate 8 causes the light emitting element 82 to emit the light L of a predetermined color and illuminates the lens 85 while power is supplied to the motors 212, 222, 231, and 241, that is, while the power of the robot 1 is turned on. Hereinafter, this state is also referred to as a first light emission state. Accordingly, the user can be easily notified that the power of the robot 1 is turned on. In addition, when the brake release button 17 is pressed and the brake 243 is brought into the brake release state, the brake control substrate 8 causes the light emitting element 82 to emit the light L of a color different from the first light emission state and illuminates the lens 85. Hereinafter, this state is also referred to as a second light emission state. Accordingly, the user can be easily notified that the brake 243 is in the brake release state. In addition, by switching between the first light emission state and the second light emission state, the user can be more clearly notified of the state of the robot 1. However, the notification method is not particularly limited. For example, the first light emission state may be lighting and the second light emission state may be extinguishing, or the first light emission state may be lighting and the second light emission state may be blinking.

The brake control substrate 8 described above includes a central processing unit (CPU), a read only memory (ROM), and the like. The functions described above are achieved as the CPU reads and executes a program and data stored in the ROM.

In addition, as illustrated in FIGS. 8 and 9, the second arm 12 has three pillars 151, 152, and 153 erected from the arm base 121 toward an upper side in the vertical direction, that is, in one side in a direction along the second rotation axis J2. Among these, the pillar 151 passes through the belt 234c wound around the second intermediate pulley 234a and the pulley 234b and extends above the belt 234c. On the other hand, each of the remaining two pillars 152 and 153 passes through an inside of the belt 242c wound around the pulley 242a and the pulley 242b and extends above the belt 242c. With such a configuration, spaces in the belts 234c and 242c can be effectively used, and an increase in size of the second arm 12 caused by disposing the pillars 151, 152, and 153 can be effectively suppressed.

In addition, the pillars 152 and 153 are disposed to be separated from each other along a length direction of the second arm 12, and the pillars 151 and 152 are disposed to be separated from each other along a width direction of the second arm 12, that is, a direction orthogonal to the length direction. In addition, the pillars 152 and 153 are coupled by a rib 154. In addition, upper surfaces of the pillars 151, 152, and 153 are flush with each other, and a screw hole, that is, a female screw 150 is formed in each of the upper surfaces.

In the present embodiment, the pillars 151, 152, and 153 are integrally formed with the arm base 121, but without being limited thereto, for example, may be formed separately from the arm base 121 and fixed to the arm base 121 by measures such as screwing, fitting, bonding, welding, and screw tightening. In addition, the pillars 151, 152, and 153 may be integrally formed with a side wall (not illustrated) of the arm base 121. In addition, the disposition of the pillars 151, 152, and 153 is not particularly limited. For example, the pillars 151, 152, and 153 may be disposed outside the belts 234c and 242c. In addition, the number of pillars is not limited to three, and may be two, or may be four or more.

In addition, as illustrated in FIGS. 9 and 10, the second arm 12 has a mounting member 16 mounted on the upper surfaces of the pillars 151, 152, and 153. The pillars 151, 152, and 153 and the mounting member 16 configure a table protruding to the upper side of the arm base 121 in the vertical direction. The mounting member 16 has a plate shape and is made of a lightweight and hard metal material such as aluminum. In addition, the mounting member 16 is positioned above the belts 234c and 242c and overlaps the space in the belt 234c and the space in the belt 242c in plan view from the direction along the second rotation axis J2. That is, the mounting member 16 overlaps a part of the belt 234c and a part of the belt 242c. With such a configuration, the spaces above the belt 234c and the belt 242c can be effectively used, and an increase in size of the second arm 12 caused by disposing the mounting member 16 can be effectively suppressed. Further, the mounting member 16 may be positioned above the first intermediate pulley 233b and may overlap at least a part of the first intermediate pulley 233b in plan view from the direction along the second rotation axis J2. With such a configuration, a space above the first intermediate pulley 233b can be effectively used, and an increase in size of the second arm 12 caused by disposing the mounting member 16 can be further effectively suppressed. However, the disposition of the mounting member 16 is not particularly limited, and for example, the mounting member 16 may be positioned below the belts 234c and 242c.

In addition, the mounting member 16 has three first screw insertion holes 161 formed at positions overlapping the female screws 150 formed at the pillars 151, 152, and 153, respectively, in plan view from the direction along the second rotation axis J2. The number of first screw insertion holes 161 is aligned with the number of female screws 150. The mounting member 16 is fixed to the pillars 151, 152, and 153 by tightening the screw B1 inserted into each of the first screw insertion holes 161 to the female screw 150 of each of the pillars 151, 152, and 153.

In addition, three second screw insertion holes 162 different from the first screw insertion holes 161 are formed in the mounting member 16. Since these three second screw insertion holes 162 are used in the robot 1 of a second embodiment to be described later, details will be described in the second embodiment. Further, a mounting member through-hole 163 penetrating an upper surface and a lower surface is formed in the mounting member 16. With such a configuration, the mounting member 16 can be reduced in weight.

Herein, temporarily returning to the description of the arm base 121, as illustrated in FIG. 8, an arm base through-hole 121a penetrating the arm base 121 in the vertical direction, that is, the direction along the second rotation axis J2 is formed in the arm base 121. The arm base through-hole 121a is positioned between the pillar 151 and the pillars 152 and 153 and overlaps the mounting member 16 in plan view from the direction along the second rotation axis J2.

Returning to the description of the mounting member 16, as illustrated in FIGS. 9 and 10, four columnar spacers 164 extending in the vertical direction are disposed at the upper surface of the mounting member 16. Each of the spacers 164 is fixed to the mounting member 16 by measures such as screwing, fitting, bonding, welding, and screw tightening. The four spacers 164 are disposed side by side to be positioned at four corners of a rectangle. In addition, an upper surface of each of the spacers 164 is at the same height with each other, and a screw hole, that is, a female screw 165 is formed in each of the upper surfaces. In plan view from the direction along the second rotation axis J2, the four female screws 165 are displaced with respect to the three female screws 150. In other words, in plan view from the direction along the second rotation axis J2, each of the female screws 165 does not overlap any of the three female screws 150.

In addition, the robot 1 has an inertia sensor module 6 disposed in the second arm 12 and mounted on the mounting member 16. The inertia sensor module 6 has a substrate 61 and an angular speed sensor 62 that is an inertia sensor which is mounted on the substrate 61 and which detects an angular speed ω of the second arm 12 around a vertical axis. In addition, the angular speed sensor 62 has a package and an angular speed sensor element and a circuit element which are accommodated in the package. The angular speed sensor element is, for example, a crystal oscillator and has a drive arm that is driven to oscillate due to application of a drive signal and a detection arm that oscillates for detection due to a Coriolis force generated by application of the angular speed ω and that outputs a signal having a magnitude corresponding thereto. In addition, the circuit element has, for example, a drive circuit that applies the drive signal to oscillate the drive arm of the crystal oscillator and a detection circuit that detects the angular speed ω based on the signal output from the detection arm. When an imaginary line segment passing through the second rotation axis J2 and the third rotation axis J3 is defined as an imaginary central axis, the inertia sensor module 6 is disposed at a position overlapping the imaginary central axis in plan view from the direction along the second rotation axis J2. However, without being limited thereto, the inertia sensor module 6 may be disposed at a position that does not overlap the imaginary central axis.

In addition, a control circuit 64 that controls driving of the angular speed sensor 62 based on a command from the control substrate 91 is formed at the substrate 61. The control circuit 64 includes a central processing unit (CPU) and a read only memory (ROM), and the functions described above are achieved by the CPU reading and executing a program or data stored in the ROM. The control circuit 64 acquires a signal from the angular speed sensor 62 and sends the signal to the control substrate 91. In addition, a connector 63 electrically coupled to the control circuit 64 is mounted on the substrate 61, and the connector 63 is electrically coupled to the control substrate 91 via the wiring 31. However, without being limited thereto, the wiring 31 may be omitted, the control circuit 64 may transmit a signal to the control substrate 91 through wireless communication, or the connector 63 may be electrically coupled to the power supply substrate 92 via the wiring 31, and the control circuit 64 may send a signal from the angular speed sensor 62 to the control substrate 91 via the power supply substrate 92.

In addition, the substrate 61 is a rectangle in plan view from the direction along the second rotation axis J2. In addition, as illustrated in FIG. 10, four screw insertion holes 611 overlapping the female screws 165 formed in the spacers 164, respectively, are formed in corner portions of the substrate 61, that is, four corners, respectively. The substrate 61 is fixed to the mounting member 16 via the spacers 164 by tightening the screw B2 inserted into each of the screw insertion holes 611 to the female screw 165 of each of the spacers 164. As described above, a posture of the inertia sensor module 6 is stabilized by fixing the four corners of the substrate 61 to the spacers 164, respectively. In addition, by fixing the substrate 61 to the mounting member 16 via the spacers 164, interference between a component mounted on a lower surface of the substrate 61 and the mounting member 16, interference between the substrate 61 and heads of the screws B1, and the like can be suppressed. The term “rectangle” is not limited to a case of matching the rectangle and includes a shape that can be regarded as the same as the rectangle from a viewpoint of technical common knowledge, such as a configuration where corner portions are chamfered, a configuration where a part is cut out, and a configuration where a part protrudes outward. However, the shape of the substrate 61 is not particularly limited and may be, for example, a polygon, such as a pentagon or more, a circle, an irregular shape, or the like. In addition, a place where the substrate 61 is fixed to the mounting member 16, that is, the position of the screw insertion hole 611 is not particularly limited and may be a position separated away from the corner portions. In addition, the number of spacers 164 may be five or more or three or less. In addition, the spacers 164 may be omitted, and the substrate 61 may be directly fixed to the mounting member 16.

In addition, the connector 63 electrically coupled to the control circuit 64 is disposed at the substrate 61, and the wiring 31 is coupled to the connector 63. The inertia sensor module 6 and the control substrate 91 are electrically coupled via the wiring 31. As described above, by disposing the connector 63 at the substrate 61, the inertia sensor module 6 and the control substrate 91 are easily coupled electrically. Further, the connector 63 is disposed along an outer edge of the substrate 61 and is positioned between a pair of screw insertion holes 611 adjacent to each other, that is, between a pair of fixing places adjacent to each other with the mounting member 16. With such disposition, the connector 63 can be supported from both sides thereof. For this reason, deformation of the substrate 61 when the wiring 31 is coupled to the connector 63 can be suppressed, and damage and failure of the inertia sensor module 6 can be effectively suppressed. In addition, the connector 63 is disposed on the upper side of the substrate 61, that is, on a side opposite to the mounting member 16. Accordingly, work of coupling the wiring 31 to the substrate 61 is easy. The connector 63 may be disposed on the lower side of the substrate 61.

Although the inertia sensor module 6 is described hereinbefore, but the inertia sensor module 6 is not particularly limited. For example, the inertia sensor is an angular speed sensor that detects the angular speed ω of the second arm 12 in the present embodiment, but without being limited thereto, may be, for example, an acceleration sensor that detects the acceleration of the second arm 12. In addition, the inertia sensor may be a composite sensor that can detect both the angular speed ω and the acceleration. In addition, the angular speed sensor element is a crystal oscillator in the present embodiment, but without being limited thereto, may be, for example, a silicon MEMS that detects the angular speed based on a change in capacitance between a movable electrode and a fixed electrode.

As described above, in the robot 1, the inertia sensor module 6 is fixed to the pillars 151, 152, and 153 via the mounting member 16. For this reason, oscillation of the arm base 121 is attenuated by the mounting member 16, and it is difficult for the oscillation to be transmitted to the inertia sensor module 6. Therefore, compared to a configuration where the inertia sensor module 6 is directly fixed to the pillars 151, 152, and 153 as in the related art, unnecessary oscillation of the inertia sensor module 6 can be suppressed, and a decrease in detection accuracy of the inertia sensor module 6 caused by the unnecessary oscillation can be suppressed. In particular, as described above, the arm base through-hole 121a is formed in the arm base 121. For this reason, the oscillation of the arm base 121 is attenuated by the arm base through-hole 121a, and it is difficult for the oscillation to be transmitted to the pillars 151, 152, and 153. Therefore, the unnecessary oscillation of the inertia sensor module 6 can be suppressed, and the decrease in the detection accuracy of the inertia sensor module 6 caused by the unnecessary oscillation can be suppressed. Further, the mounting member through-hole 163 is formed in the mounting member 16. For this reason, the oscillation of the arm base 121 is attenuated by the mounting member through-hole 163, and it is difficult for the oscillation to be transmitted to the inertia sensor module 6. Therefore, the unnecessary oscillation of the inertia sensor module 6 can be suppressed, and the decrease in the detection accuracy of the inertia sensor module 6 caused by the unnecessary oscillation can be suppressed.

Further, as described above, the substrate 61 of the inertia sensor module 6 is a rectangle, and the four corners thereof are fixed to the mounting member 16. For this reason, the posture of the inertia sensor module 6 is stabilized, and it is difficult for the inertia sensor module 6 to oscillate. Therefore, a decrease in the detection accuracy of the inertia sensor module 6 caused by unnecessary oscillation can be more effectively suppressed. In addition, as described above, the inertia sensor module 6 is fixed to the mounting member 16 via the spacer 164. For this reason, an oscillation propagation route from the arm base 121 to the inertia sensor module 6 can be made longer, and it is difficult for the oscillation of the arm base 121 to be transmitted to the inertia sensor module 6. For this reason, the inertia sensor module 6 is unlikely to oscillate, and a decrease in the detection accuracy of the inertia sensor module 6 caused by unnecessary oscillation can be more effectively suppressed.

In addition, as described above, in plan view from the direction along the second rotation axis J2, the four female screws 165, which are at the fixing places between the inertia sensor module 6 and the mounting member 16, are displaced with respect to the three female screws 150, which are the fixing places between the mounting member 16 and the pillars 151, 152, and 153. For this reason, the oscillation propagation route from the arm base 121 to the inertia sensor module 6 can be made longer, and it is more difficult for the oscillation of the arm base 121 to be transmitted to the inertia sensor module 6. For this reason, the inertia sensor module 6 is unlikely to oscillate, and a decrease in the detection accuracy of the inertia sensor module 6 caused by unnecessary oscillation can be more effectively suppressed. In addition, as described above, the connector 63 is disposed between a pair of fixing places adjacent to each other with the mounting member 16 and is supported from both sides thereof. For this reason, the connector 63 is unlikely to oscillate, and as a result, oscillation of the inertia sensor module 6 caused by oscillation of the wiring 31 is suppressed.

The robot system 100 is described hereinbefore. The robot 1 included in such a robot system 100 has the base 10, the first arm 11 that is joined to the base 10 and that rotates around the first rotation axis J1 with respect to the base 10, the second arm 12 that is joined to the first arm 11 and that rotates around the second rotation axis J2, which is parallel to the first rotation axis J1, with respect to the first arm 11, and the inertia sensor module 6 that is disposed at the second arm 12. In addition, the second arm 12 has the arm base 121 that is joined to the first arm 11, the plurality of pillars 151, 152, and 153 erected from the arm base 121 toward the one side in the direction along the second rotation axis J2, that is, the upper side in the vertical direction, and the mounting member 16 that is fixed to the plurality of pillars 151, 152, and 153. The inertia sensor module 6 is fixed to the mounting member 16. With such a configuration, oscillation of the arm base 121 is attenuated by the mounting member 16 and is unlikely to be transmitted to the inertia sensor module 6. Therefore, compared to a configuration where the inertia sensor module 6 is directly fixed to the pillars 151, 152, and 153 as in the related art, unnecessary oscillation of the inertia sensor module 6 is suppressed, and a decrease in detection accuracy of the inertia sensor module 6 caused by the unnecessary oscillation can be suppressed.

In addition, as described above, the robot 1 has the work head 13 that includes the spline shaft 133 which is disposed at the second arm 12 and which is disposed along the third rotation axis J3 parallel to the first rotation axis J1 and the spline nut 131 and the ball screw nut 132 which are mounted on the spline shaft 133, and in which the spline shaft 133 at least rotates around the third rotation axis J3 when the spline nut 131 is rotated, and the spline shaft 133 linearly moves along the third rotation axis J3 when the ball screw nut 132 is rotated, the spline shaft first drive mechanism 23 that includes the motor 231 which is the first motor and the deceleration mechanism 232 which is the first power transmission mechanism transmitting rotation of the motor 231 to the spline nut 131, and in which the deceleration mechanism 232 includes the pulley 234b which is the first pulley fixed to the spline nut 131 and the belt 234c which is the first belt wound around the pulley 234b, and the spline shaft second drive mechanism 24 that includes the motor 241 which is the second motor and the deceleration mechanism 242 which is the second power transmission mechanism transmitting rotation of the motor 241 to the ball screw nut 132, and in which the deceleration mechanism 242 includes the pulley 242b which is the second pulley fixed to the ball screw nut 132 and the belt 242c which is the second belt wound around the pulley 242b. The mounting member 16 is positioned on one side of the belts 234c and 242c in the direction along the second rotation axis J2, that is, on the upper side in the vertical direction and overlaps the belts 234c and 242c in plan view from the direction along the second rotation axis J2. With such a configuration, the spaces above the belts 234c and 242c can be effectively used, and an increase in size of the second arm 12 caused by disposing the mounting member 16 can be effectively suppressed.

In addition, as described above, the inertia sensor module 6 has the substrate 61 and the angular speed sensor 62 which is an inertia sensor disposed at the substrate 61. The substrate 61 is a rectangle in plan view and is fixed to the mounting member 16 at each corner portion. With such a configuration, the posture of the inertia sensor module 6 is stabilized, and the inertia sensor module 6 is unlikely to oscillate. Therefore, a decrease in the detection accuracy of the inertia sensor module 6 caused by unnecessary oscillation can be more effectively suppressed.

In addition, as described above, the inertia sensor module 6 has, on the substrate 61, the connector 63 disposed between the pair of fixing places adjacent to each other with the mounting member 16. With such a configuration, the connector 63 is supported from both sides thereof and is unlikely to oscillate. For this reason, oscillation of the inertia sensor module 6 caused by oscillation of the wiring 31 coupled to the connector 63 is suppressed, and a decrease in the detection accuracy of the inertia sensor module 6 caused by unnecessary oscillation can be more effectively suppressed.

In addition, as described above, the inertia sensor module 6 is fixed to the mounting member 16 via the spacer 164. With such a configuration, the oscillation propagation route from the arm base 121 to the inertia sensor module 6 can be made longer, and the oscillation of the arm base 121 is unlikely to be transmitted to the inertia sensor module 6. For this reason, the inertia sensor module 6 is unlikely to oscillate, and a decrease in the detection accuracy of the inertia sensor module 6 caused by unnecessary oscillation can be more effectively suppressed.

In addition, as described above, in plan view from the direction along the second rotation axis J2, the fixing places between the inertia sensor module 6 and the mounting member 16 are displaced with respect to the fixing places between the mounting member 16 and the pillars 151, 152, and 153. With such a configuration, the oscillation propagation route from the arm base 121 to the inertia sensor module 6 can be made longer, and the oscillation of the arm base 121 is unlikely to be transmitted to the inertia sensor module 6. For this reason, the inertia sensor module 6 is unlikely to oscillate, and a decrease in the detection accuracy of the inertia sensor module 6 caused by unnecessary oscillation can be more effectively suppressed.

In addition, as described above, the robot 1 has the mounting member through-hole 163 penetrating the mounting member 16 in the direction along the second rotation axis J2. With such a configuration, oscillation of the arm base 121 is attenuated by the mounting member through-hole 163, and the oscillation is unlikely to be transmitted to the inertia sensor module 6. Therefore, unnecessary oscillation of the inertia sensor module 6 can be suppressed, and a decrease in the detection accuracy of the inertia sensor module 6 caused by the unnecessary oscillation can be suppressed.

In addition, as described above, the robot 1 has the arm base through-hole 121a that penetrates the arm base 121 in the direction along the second rotation axis J2. The arm base through-hole 121a is positioned between two pillars selected from the plurality of pillars 151, 152, and 153, and in the present embodiment, between the pillar 151 and the pillars 152 and 153. With such a configuration, the oscillation of the arm base 121 is attenuated by the arm base through-hole 121a, and the oscillation is unlikely to be transmitted to the pillars 151, 152, and 153. Therefore, unnecessary oscillation of the inertia sensor module 6 can be suppressed, and a decrease in the detection accuracy of the inertia sensor module 6 caused by the unnecessary oscillation can be suppressed.

In addition, as described above, the robot system 100 has the robot 1 and the control device 9 that controls driving of the robot 1. In addition, the robot 1 has the base 10, the first arm 11 that is joined to the base 10 and that rotates around the first rotation axis J1 with respect to the base 10, the second arm 12 that is joined to the first arm 11 and that rotates around the second rotation axis J2, which is parallel to the first rotation axis J1, with respect to the first arm 11, and the inertia sensor module 6 that is disposed at the second arm 12. In addition, the second arm 12 has the arm base 121 that is joined to the first arm 11, the plurality of pillars 151, 152, and 153 erected from the arm base 121 toward the one side in the direction along the second rotation axis J2, that is, the upper side in the vertical direction, and the mounting member 16 that is fixed to the plurality of pillars 151, 152, and 153. The inertia sensor module 6 is fixed to the mounting member 16. With such a configuration, oscillation transmitted from the arm base 121 is attenuated by the mounting member 16, and the oscillation is unlikely to be transmitted to the inertia sensor module 6. Therefore, compared to a configuration where the inertia sensor module 6 is directly fixed to the pillars 151, 152, and 153 as in the related art, unnecessary oscillation of the inertia sensor module 6 is suppressed, and a decrease in detection accuracy of the inertia sensor module 6 caused by the unnecessary oscillation can be suppressed.

### Second Embodiment

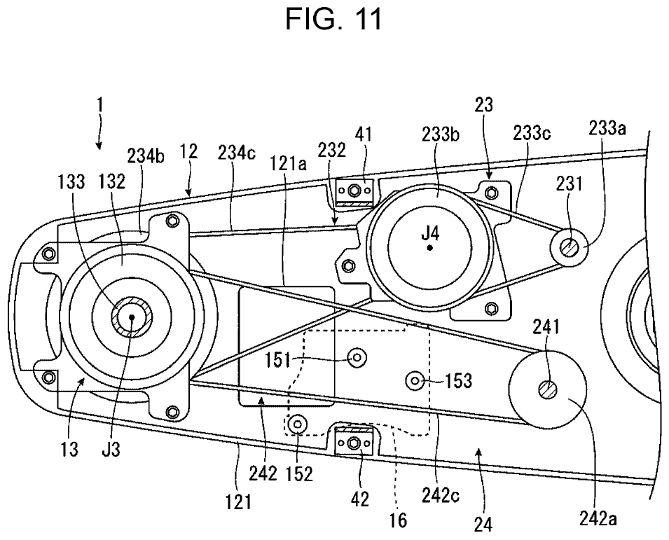

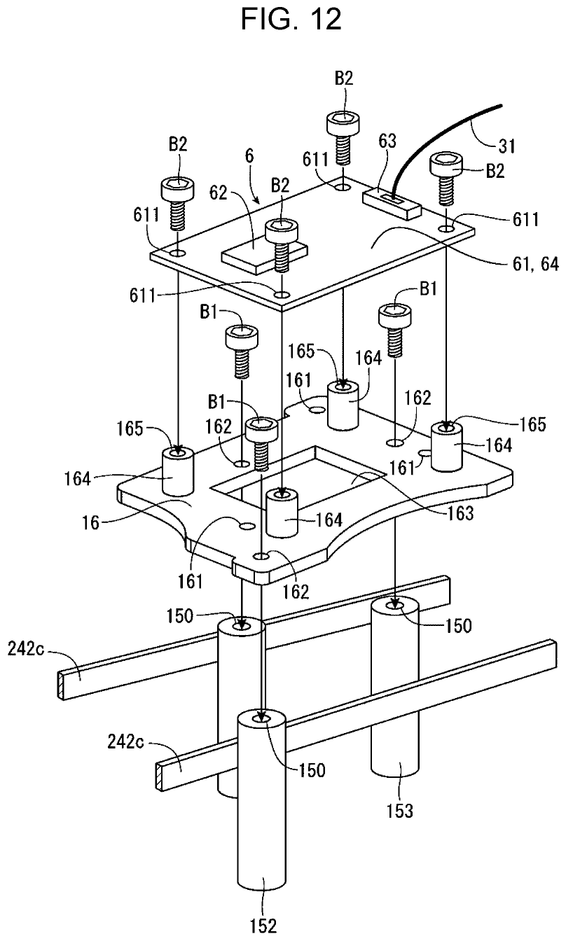

FIG. 11 is a top view illustrating an inside of a second arm of a robot according to the second embodiment. FIG. 12 is an exploded perspective view illustrating the vicinity of a mounting member.

The robot 1 according to the present embodiment is the same as the robot 1 of the first embodiment described above except that the disposition of the pillars 151, 152, and 153 and the direction of the mounting member 16 are different. In the following description, the robot 1 of the present embodiment will be described with a focus on differences from the first embodiment described above, and description of the same matters will be omitted. In addition, in each drawing of the present embodiment, the same reference numerals are given to the same configurations as those in the embodiment described above.

As illustrated in FIG. 11, in the robot 1 of the present embodiment, among the three pillars 151, 152, and 153, the pillars 151 and 153 pass through the inside of the belt 242c wound around the pulleys 242a and 242b and extend above the belt 242c. On the other hand, the remaining pillar 152 passes through an outside of the belt 242c and extends above the belt 242c. A relative positional relationship between the pillars 151, 152, and 153 matches a relative positional relationship between the three second screw insertion holes 162 when the mounting member 16 is in a posture rotated by 90° around the vertical axis (hereinafter, simply referred to as a “second posture”) from the posture of the first embodiment (hereinafter, simply referred to as a “first posture”). As illustrated in FIG. 12, the mounting member 16 in the second posture is fixed to the pillars 151, 152, and 153 by the screws B1 inserted into the second screw insertion holes 162.

As described above, by forming, in the mounting member 16, the first screw insertion holes 161 used in fixing in the first posture and the second screw insertion holes 162 used in fixing in the second posture, a degree of freedom in disposition of the pillars 151, 152, and 153 is increased. That is, whether to fix the mounting member 16 in the first posture or the second posture can be selected based on the disposition of other members. Therefore, it is easy to design the robot 1.

As described above, in the robot 1 of the present embodiment, the mounting member 16 is fixed to each of the pillars 151, 152, and 153 by the screws B1 and has the first screw insertion holes 161 through which the screws B1 are inserted when the mounting member 16 is in the first posture and the second screw insertion holes 162 through which the screws B2 are inserted when the mounting member 16 is in the second posture different from the first posture. With such a configuration, a degree of freedom in the disposition of the pillars 151, 152, and 153 is increased. That is, whether to fix the mounting member 16 in the first posture or the second posture can be selected based on the disposition of other members. For this reason, it is easy to design the robot 1.

Even in such a second embodiment, the same effect as that of the first embodiment described above can be exhibited.

The robot and the robot system of the present disclosure are described hereinbefore based on the illustrated embodiments. However, the present disclosure is not limited thereto, and the configuration of each portion can be replaced with any configuration having the same function. In addition, any other configurations may be added to the present disclosure. For example, in the embodiments described above, the robot 1 has the duct 14, but the duct 14 may be omitted. In this case, the wiring 31 is drawn to the base 10 and the second arm 12 via the inside of the first arm 11. In addition, the robot 1 is a floor-standing type SCARA robot in which the base 10 is fixed to the floor or the like in the embodiments described above, but may be a ceiling-hanging type SCARA robot in which the base 10 is hung from a ceiling. In this case, the base 10 is hung from, for example, a top plate positioned above a frame-shaped leg portion of a stand.

1. A robot comprising:
a base;
a first arm that is joined to the base and that rotates around a first rotation axis with respect to the base;
a second arm that is joined to the first arm and that rotates around a second rotation axis, which is parallel to the first rotation axis, with respect to the first arm; and
an inertia sensor module that is disposed at the second arm, wherein
the second arm has an arm base that is joined to the first arm, a plurality of pillars that are erected from the arm base toward one side in a direction along the second rotation axis, and a mounting member that is fixed to the plurality of pillars, and
the inertia sensor module is fixed to the mounting member.

2. The robot according to claim 1, further comprising:
a work head that includes a spline shaft which is disposed at the second arm and which is disposed along a third rotation axis, which is parallel to the first rotation axis and a spline nut and a ball screw nut which are mounted on the spline shaft, and in which the spline shaft at least rotates around the third rotation axis when the spline nut is rotated, and the spline shaft linearly moves along the third rotation axis when the ball screw nut is rotated;
a spline shaft first drive mechanism that includes a first motor, a first power transmission mechanism which transmits rotation of the first motor to the spline nut, and in which the first power transmission mechanism includes a first pulley which is fixed to the spline nut and a first belt which is wound around the first pulley; and
a spline shaft second drive mechanism that includes a second motor and a second power transmission mechanism which transmits rotation of the second motor to the ball screw nut, and in which the second power transmission mechanism includes a second pulley which is fixed to the ball screw nut and a second belt which is wound around the second pulley, wherein
the mounting member is positioned on the one side of the first belt and the second belt in the direction along the second rotation axis and overlaps the first belt and the second belt in plan view from the direction along the second rotation axis.

3. The robot according to claim 1, wherein
the inertia sensor module has a substrate and an inertia sensor that is disposed at the substrate, and
the substrate is a rectangle in plan view and is fixed to the mounting member at each corner portion.

4. The robot according to claim 3, wherein
the inertia sensor module has, on the substrate, a connector that is disposed between a pair of fixing places adjacent to each other with the mounting member.

5. The robot according to claim 1, wherein
the inertia sensor module is fixed to the mounting member via a spacer.

6. The robot according to claim 1, wherein
in plan view from the direction along the second rotation axis, a fixing place between the inertia sensor module and the mounting member is displaced with respect to a fixing place between the mounting member and each of the pillars.

7. The robot according to claim 1, further comprising:
a mounting member through-hole that penetrates the mounting member in the direction along the second rotation axis.

8. The robot according to claim 1, further comprising:
an arm base through-hole that penetrates the arm base in the direction along the second rotation axis, wherein
the arm base through-hole is positioned between two pillars selected from the plurality of pillars.

9. The robot according to claim 1, wherein
the mounting member is fixed to each of the pillars by a screw, and
the mounting member has
a first screw insertion hole through which the screw is inserted when the mounting member is in a first posture, and
a second screw insertion hole through which the screw is inserted when the mounting member is in a second posture different from the first posture.

10. The robot according to claim 1, further comprising:
a work head that includes a spline shaft which is disposed at the second arm and which is disposed along a third rotation axis parallel to the first rotation axis and a spline nut and a ball screw nut which are mounted on the spline shaft, and in which the spline shaft rotates around the third rotation axis when the spline nut is rotated, and the spline shaft linearly moves along the third rotation axis when the ball screw nut is rotated;
a spline shaft first drive mechanism that includes a first motor, a first power transmission mechanism which transmits rotation of the first motor to the spline nut, and in which the first power transmission mechanism includes a first pulley which is fixed to the spline nut and a first belt which is wound around the first pulley;
a spline shaft second drive mechanism that includes a second motor and a second power transmission mechanism which transmits rotation of the second motor to the ball screw nut, and in which the second power transmission mechanism includes a second pulley which is fixed to the ball screw nut and a second belt which is wound around the second pulley;
a mounting member through-hole that penetrates the mounting member in the direction along the second rotation axis; and
an arm base through-hole that penetrates the arm base in the direction along the second rotation axis and that overlaps the mounting member in plan view from the direction along the second rotation axis, wherein
the mounting member is positioned on the one side of the first belt and the second belt in the direction along the second rotation axis and overlaps the first belt and the second belt in plan view from the direction along the second rotation axis,
the mounting member is fixed to each of the pillars by a screw and further has a first screw insertion hole through which the screw is inserted when the mounting member is in a first posture and a second screw insertion hole through which the screw is inserted when the mounting member is in a second posture different from the first posture,
the inertia sensor module has a circuit substrate and an inertia sensor mounted on the circuit substrate,
the circuit substrate is a rectangle in plan view from the direction along the second rotation axis, is fixed to the mounting member via a spacer at each corner portion of the rectangle, and has a connector that is disposed between a pair of fixing places adjacent to each other with the mounting member and that is electrically coupled to another electronic device, and
in plan view from the direction along the second rotation axis, a fixing place between the circuit substrate and the mounting member is displaced with respect to a fixing place between the mounting member and each of the pillars.

11. A robot system comprising:
a robot; and
a control device that controls driving of the robot, wherein
the robot includes
a base,
a first arm that is joined to the base and that rotates around a first rotation axis with respect to the base,
a second arm that is joined to the first arm and that rotates around a second rotation axis, which is parallel to the first rotation axis, with respect to the first arm, and
an inertia sensor module that is disposed at the second arm,
the second arm has an arm base that is joined to the first arm, a plurality of pillars that are erected from the arm base toward one side in a direction along the second rotation axis, and a mounting member that is fixed to the plurality of pillars, and
the inertia sensor module is fixed to the mounting member.
